(19) United States
(12) Patent Application Publication
(10) Pub. No.: US 2004/0061569 A1
(43) Pub. Date: Apr. 1, 2004

(54) ADSL customer premises subscriber loop equalizer

(76) Inventor: Naom Chaplik, San Diego, CA (US)

Correspondence Address: TEXAS INSTRUMENTS INCORPORATED, P O BOX 655474, M/S 3999, DALLAS, TX, 75265

(21) Appl. No.: 10/281,755

(22) Filed: Oct. 28, 2002

Related U.S. Application Data
(60) Provisional application No. 60/414,015, filed on Sep. 27, 2002.

(51) Int. Cl. H04B 3/04

(52) U.S. Cl. 333/28 R

(57) ABSTRACT

An ADSL subscriber loop equalizer architecture 100 employs a circuit having a capacitor 102 connected to ground as a basic building block; where the capacitor 102 is much smaller than equivalent capacitors that must be employed using known ADSL CP subscriber loop equalizer architectures. The ADSL subscriber loop equalizer is adaptive to provide different levels of equalization in response to a selector switch setting.

### CLAIM TO PRIORITY OF PROVISIONAL APPLICATION

This application claims priority under 35 U.S.C. § 119(e)(1) of provisional application serial No. 60/414,015, docket number TI-34474P, filed Sep. 27, 2002, by Naom Chaplik.

### BACKGROUND OF THE INVENTION

1. Field of the Invention

This invention relates generally to subscriber loop equalizers, and more particularly to an asymmetric digital subscriber line (ADSL) customer premises (CP) subscriber loop equalizer architecture that employs a circuit having a capacitor connected to ground as a basic building block.

2. Description of the Prior Art

Subscriber loops have frequency performance that can be characterized by higher attenuation at high frequencies. Since associated analog to digital (A/D) converter performance worsens at higher frequencies, ADSL performance at high bit rates degrades as well.

A high pass equalizer is generally employed to compensate subscriber loop attenuation at high frequencies. Because conditions associated with subscriber loops vary widely, these ADSL equalizers are adaptive, with frequency performance changing according to the loop conditions. The nature of equalization (reduction of attenuation at high frequencies) implies use of capacitors not connected to ground. This is problematic since the values of capacitors not connected to ground in a single ended version of an equalizer circuit are doubled when used in a fully differential version; and these capacitors are much too large for use in ADSL equalizers.

It is therefore both advantageous and desirable in view of the foregoing, to provide an ADSL CP subscriber loop equalizer architecture that employs a circuit having a capacitor connected to ground as a basic building block; where the capacitor is much smaller than capacitors that must be employed using known ADSL CP subscriber loop equalizer architectures.

### SUMMARY OF THE INVENTION

The present invention is directed to an ADSL CP subscriber loop equalizer architecture that employs a circuit having a capacitor connected to ground as a basic building block; where the capacitor is much smaller than capacitors that must be employed using known ADSL CP subscriber loop equalizer architectures.

According to one embodiment, an ADSL subscriber loop equalizer comprises at least one operational amplifier; a resistor network connected to the at least one operational amplifier; and at least one capacitor connected between ground and the resistor network such that the at least one operational amplifier, resistor network and at least one capacitor are configured to provide an ADSL subscriber loop equalizer having capacitors substantially smaller than an ADSL subscriber loop equalizer that is devoid of any capacitors connected to ground, and further such that the ADSL subscriber loop equalizer having at least one capacitor connected between ground and the resistor network provides substantially identical gain performance as that provided by the ADSL subscriber loop equalizer that is devoid of any capacitors connected to ground.

According to another embodiment, an ADSL subscriber loop equalizer comprises at least one operational amplifier; a plurality of resistor networks connected to the at least one operational amplifier; and at least one capacitor associated with each resistor network selected from among the plurality of resistor networks, each at least one capacitor connected between ground and its respective resistor network, such that the at least one operational amplifier, plurality of resistor networks and at least one capacitor connected between ground and each resistor network are configured to provide an ADSL subscriber loop equalizer having capacitors substantially smaller than an ADSL subscriber loop equalizer that is devoid of any capacitors connected to ground, and further such that the ADSL subscriber loop equalizer having at least one capacitor connected between ground and each resistor network provides substantially identical gain performance as that provided by the ADSL subscriber loop equalizer that is devoid of any capacitors connected to ground.

According to yet another embodiment, a method of providing compensation for an ADSL subscriber loop at high frequencies comprises the steps of providing a high pass ADSL subscriber loop equalizer having at least one filter capacitor connected to ground; and processing a signal passing through the high pass ADSL subscriber loop equalizer to reduce its high frequency attenuation.

### BRIEF DESCRIPTION OF THE DRAWINGS

Other aspects and features of the present invention and many of the attendant advantages of the present invention will be readily appreciated as the same become better understood by reference to the following detailed description when considered in connection with the accompanying drawing figures wherein:

FIG. 1 is a schematic diagram illustrating a single ended equalizer circuit having a capacitor connected to ground according to one embodiment of the present invention;

FIG. 2 is a schematic diagram illustrating another single ended equalizer circuit according to one embodiment of the present invention and that employs a combination of two circuits using the general circuit architecture shown in FIG. 1;

FIG. 3 is a gain versus frequency graph for the equalizer circuit shown in FIG. 2 when the switch ‘S’ is in position ‘A’; and

FIG. 4 is a gain versus frequency graph for the equalizer circuit shown in FIG. 2 when the switch ‘S’ is in position ‘B’.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

FIG. 1 is a schematic diagram illustrating a single ended equalizer circuit 100 having a capacitor 102 connected to ground according to one embodiment of the present invention. The present inventor found that the capacitance value for capacitor 102 could be reduced by about a factor of 4 to achieve results similar to that achievable using a known equalizer circuit architecture that does not employ a capacitor connected to ground. The transfer function associated with single ended equalizer circuit 100 can be defined by

$$\begin{matrix}T ( s ) = K \cdot \frac{B1 \cdot s + 1}{A1 \cdot s + 1} \\ T ( s ) = \frac{R31 + R16}{R29} \cdot \frac{1 + s \cdot C6 \cdot ( R8 + \frac{R31 \cdot R16}{R31 + R16} )}{1 + s \cdot C6 \cdot R8}\end{matrix}$$

Since B1 can be easily seen to be bigger than A1, the gain of the single ended equalizer circuit 100 at high frequency is higher than the gain at low frequency.

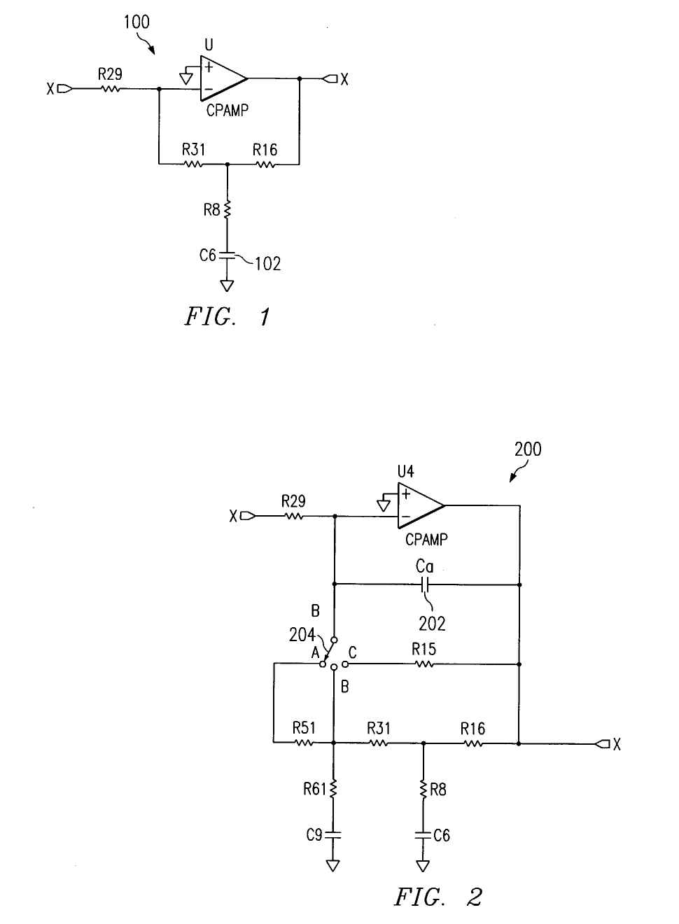

FIG. 2 is a schematic diagram illustrating another single ended equalizer circuit 200 according to one embodiment of the present invention and that employs a combination of two circuits using the general circuit architecture shown in FIG. 1. Single ended equalizer circuit 200 includes a low value capacitor 202 to provide low pass filtering in the frequency range above the bandwidth of its associated downstream signal. A switch 204 is included to provide high pass equalization in three increments. When switch 204 is in position ‘C’ (first increment), there is no equalization. When switch 204 is in position ‘B’ (second increment), a first level of equalization is provided. Finally, a second level of equalization is provided when switch 204 is in position ‘A’ (third increment).

FIG. 3 is a gain versus frequency graph for the equalizer circuit 200 shown in FIG. 2 when the switch 204 is in position ‘A’.

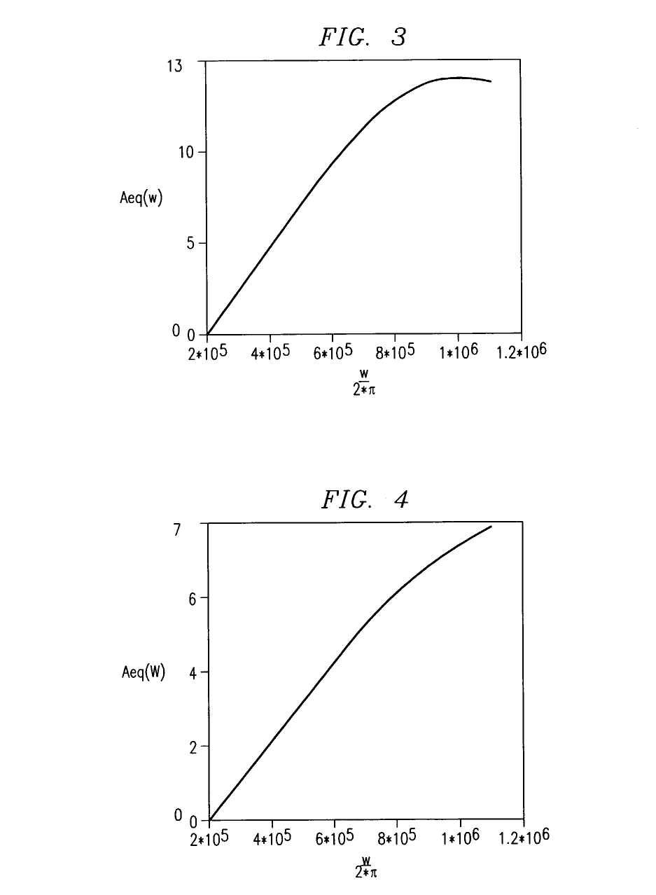

FIG. 4 is a gain versus frequency graph for the equalizer circuit 200 shown in FIG. 2 when the switch 204 is in position ‘B’.

The circuit performance depicted in FIGS. 3 and 4 was achieved using component values as follows:

R29=42107 Ohms

R16=22837 Ohms

R15=7995 O hms

R8=4600 O hms

R31=7995 O hms

R51=6714 O hms

R61=6440 O hms

C6=26.63 pF

C9=39.95 pF

Ca=0.716 pF

In summary explanation, an ADSL CP subscriber loop equalizer architecture is provided that employs a circuit having a capacitor connected to ground as a basic building block, wherein the capacitor is much smaller than capacitors that must be employed using known ADSL CP subscriber loop equalizer architectures.

In view of the above, it can be seen the present invention presents a significant advancement in the art of ADSL CP subscriber loop equalization techniques. Further, this invention has been described in considerable detail in order to provide those skilled in the active filter art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. An ADSL subscriber loop equalizer comprising:
at least one operational amplifier;
a resistor network connected to the at least one operational amplifier;
a selector switch; and
at least one capacitor connected between ground and the resistor network via the selector switch such that the at least one operational amplifier, resistor network and at least one capacitor are configured to provide an ADSL subscriber loop equalizer having a different equalization level associated with each selector switch position and further such that the ADSL subscriber loop equalizer has capacitors substantially smaller than an ADSL subscriber loop equalizer that is devoid of any capacitors connected to ground, and further such that the ADSL subscriber loop equalizer having at least one capacitor connected between ground and the resistor network provides substantially identical gain performance as that provided by the ADSL subscriber loop equalizer that is devoid of any capacitors connected to ground.

2. The ADSL subscriber loop equalizer according to claim 1 wherein the at least one capacitor connected between ground and the resistor network has a capacitance value that is about four times less than the capacitance value associated with the ADSL subscriber loop equalizer that is devoid of any capacitors connected to ground.

3. The ADSL subscriber loop equalizer according to claim 1 further comprising:
at least one feedback capacitor; and
a switch configured to selectively connect the at least one capacitor and the at least one feedback capacitor into the ADSL subscriber loop equalizer to provide a desired level of equalization.

4. The ADSL subscriber loop equalizer according to claim 3 wherein the switch is further configured to selectively connect the at least one capacitor and the at least one feedback capacitor into the ADSL subscriber loop equalizer to provide low pass filtering in the frequency range above the bandwidth of an ADSL downstream signal.

5. The ADSL subscriber loop equalizer according to claim 3 wherein the switch is further configured to selectively connect the at least one capacitor and the at least one feedback capacitor into the ADSL subscriber loop equalizer to eliminate compensation of ADSL subscriber loop attenuation at high frequencies.

6. An ADSL subscriber loop equalizer comprising:
at least one operational amplifier;
a plurality of resistor networks connected to the at least one operational amplifier;
a selector switch; and
at least one capacitor associated with each resistor network selected from among the plurality of resistor networks, each at least one capacitor connected between ground and its respective resistor network via the selector switch, such that the at least one operational amplifier, plurality of resistor networks and at least one capacitor connected between ground and its respective resistor network are configured to provide an ADSL subscriber loop equalizer a different equalization level associated with each selector switch position and further such that the ADSL subscriber loop equalizer has capacitors substantially smaller than an ADSL subscriber loop equalizer that is devoid of any capacitors connected to ground, and further such that the ADSL subscriber loop equalizer having at least one capacitor connected between ground and each resistor network provides substantially identical gain performance as that provided by the ADSL subscriber loop equalizer that is devoid of any capacitors connected to ground.

7. The ADSL subscriber loop equalizer according to claim 6 wherein the at least one capacitor connected between ground and each resistor network has a capacitance value that is about four times less than its capacitance value will be when it is associated with the ADSL subscriber loop equalizer that is devoid of any capacitors connected to ground.

8. The ADSL subscriber loop equalizer according to claim 6 further comprising:
at least one feedback capacitor; and
a switch configured to selectively connect the at least one capacitor connected between ground and each resistor network and the at least one feedback capacitor into the ADSL subscriber loop equalizer to provide a desired level of equalization.

9. The ADSL subscriber loop equalizer according to claim 8 wherein the switch is further configured to selectively connect the at least one capacitor connected between ground and each resistor network and the at least one feedback capacitor into the ADSL subscriber loop equalizer to provide low pass filtering in the frequency range above the bandwidth of an ADSL downstream signal.

10. The ADSL subscriber loop equalizer according to claim 8 wherein the switch is further configured to selectively connect the at least one capacitor connected between ground and each resistor network and the at least one feedback capacitor into the ADSL subscriber loop equalizer to eliminate compensation of ADSL subscriber loop attenuation at high frequencies.

11. A method of providing compensation for an ADSL subscriber loop at high frequencies, the method comprising the steps of:
providing an adaptive high pass ADSL subscriber loop equalizer having at least one filter capacitor connected to ground via a selector switch such that the ADSL subscriber loop equalizer has a different equalization level associated with each selector switch position; and
processing a signal passing through the high pass ADSL subscriber loop equalizer to reduce its high frequency attenuation.
